(19) United States
(12) Patent Application Publication
(10) Pub. No.: US 2020/0351352 A1
(43) Pub. Date: Nov. 5, 2020

(54) Semantic Ontology-Based Internet Scale Communication Method of Machine Tools for Providing Remote Operational Services

(71) Applicant: BOARD OF TRUSTEES OF THE UNIVERSITY OF ARKANSAS, Fayetteville, AR (US)

(72) Inventors: Xiaoqing Liu, Fayetteville, AR (US); S M Nahian Al Sunny, Fayetteville, AR (US); Md Rakib Shahriar, Fayetteville, AR (US)

(73) Assignee: BOARD OF TRUSTEES OF THE UNIVERSITY OF ARKANSAS, Fayetteville, AR (US)

(21) Appl. No.: 16/931,274

(22) Filed: Jul. 16, 2020

Related U.S. Application Data
(63) Continuation of application No. 16/020,795, filed on Jun. 27, 2018.
(60) Provisional application No. 62/525,497, filed on Jun. 27, 2017.

(51) Int. Cl. H04L 29/08; G05B 15/02; G06F 16/832; G06F 16/835; G05B 19/418

(52) U.S. Cl. CPC H04L 67/125; H04L 67/025; G05B 15/02; G05B 19/182; G06F 16/8373; G05B 19/4185; G06F 16/832

(57) ABSTRACT

A system and method of connecting remotely located machine tools over the Internet. An agent-adapter architecture is used to transform the machine tools into IoT devices in a connected group that communicates with each other for exchanging their status information and executing operations remotely over the Internet.

### RELATED APPLICATIONS

This application is a continuation of U.S. Ser. No. 16/020,795 filed on Jun. 27, 2018, which claims the benefit of U.S. Provisional Application No. 62/525,497 filed Jun. 27, 2017 both of which are herein incorporated by reference.

### STATEMENT REGARDING FEDERALLY SPONSORED RESEARCH & DEVELOPMENT

This invention was made with government support by NSF Grant CMMI 1551448 entitled “EAGER/Cybermanufacturing: Architecture and Protocols for Scalable Cyber-Physical Manufacturing Systems”. The government has certain rights in the invention.

### INCORPORATION BY REFERENCE OF MATERIAL SUBMITTED ON A COMPACT DISC

Not applicable.

### BACKGROUND OF THE INVENTION

The emergence of Internet-of-Things (IoT) has been quite radical and promising. IoT technologies have been reshaping many domains including manufacturing and industrial production. With the support of IoT technologies such as RFID, embedded systems, and intelligent sensors, both physical manufacturing resources and manufacturing software can be intelligently linked to the broader networks and used across the Internet. The IoT has already initiated the development of many innovative applications by connecting devices in physical environments to the cyber world.

One of such promising advancements is the Cyber-Physical Systems (CPS). CPS is similar to the Internet of Things (IoT) and both have many common basic principles. Nevertheless, CPS presents a higher degree of coordination and combination between physical and computational elements. The potential of CPSs in smart manufacturing is enormous. CPSs are also considered to be the backbone of Industry 4.0, which is believed to be the future of the manufacturing paradigm. The concept of Cyber-physical production system (CPPS) has been introduced. Various architectures and applications of CPPSs have been proposed and analyzed recently. Although numerous manufacturing machine tools are network compatible nowadays, very few of them are operated actually in a networked environment, mostly due to lack of standardized communication protocols for connecting machine tools physically over the Internet. Cloud Manufacturing (CMfg), another emerging manufacturing paradigm, can address this issue by providing manufacturing services over cyberspace based on integration of advanced manufacturing with cloud computing. Cloud manufacturing includes research in the field of virtualization, perception of devices, and general architectures of cloud computing.

All these emerging technologies—IoT, CPS, and CMfg, are in their infancy in the manufacturing domain and are yet to be fully exploited. IoT technologies can be used in many industrial domains, such as design and development of enterprise information systems, data management and processing systems, energy management and monitoring for infrastructures and systems, service oriented and intelligent systems. In recent years, research has been conducted on the broad impact of various cloud architectures and manufacturing CPSs. Very few studies are found on integrating IoT, CPS, and CMfg to implement a real IoT enabled cloud-based CPS. A Cyber-Physical Manufacturing Cloud (CPMC) has been introduced which connects manufacturing machine tools physically to the Internet through IoT technologies and makes manufacturing facilities available through cloud-based services. FIG. 1 illustrates the conceptual framework of the CPMC. The CPMC enables remote monitoring and operation of manufacturing machine tools for the manufacturers. The basic concept is to connect manufacturing machine tools to cloud applications and provide remote access for both consumers and manufacturers to manufacturing services from the cloud. The manufacturing devices and services are represented through Representational State Transfer-based (or RESTful) web services. One of the major challenges in developing such a system is that there is no communication method which can support this type of operations. Recently MTConnect has become a widely accepted communication standard for collecting monitoring data from machine tools. But MTConnect only provides monitoring capabilities, it cannot be used to operate machine tools remotely. Therefore, an Internet scale communication method with both monitoring and operational capabilities for machining tools needs to be developed in CPMC.

### BRIEF SUMMARY OF THE INVENTION

The existing communication standards are not completely feasible and sufficient to develop a CPMC system. To address this issue, in one embodiment, the present invention provides an Internet-scale communication method hereinafter referred to as Machine Tool Communication (MTComm) to exchange operational services between machine tools across the Internet. The present invention may also be used to communicate machining operations between machine tools and the cloud in a CPMC. The present invention is a significant improvement over MTConnect as it supports operating manufacturing machine tools alongside monitoring them over the Internet. In a preferred embodiment, the present invention provides a method that is based on a semantic ontological representation of machine tools and supports both machine tool monitoring and their operations. The present invention is an application level communication method and is based on HTTP. The format of messages in a preferred embodiment is Extensible Markup Language (XML). The embodiment is designed in such a way that various machine tools using heterogeneous machine specific languages can interact with each other and be connected to a cloud through RESTful web services.

The existing machine tool communication method MTConnect has a mechanism of acquiring status information of machine tools over the Internet and to use it for monitoring machine tools remotely. However, it does not allow operations of machine tools over the Internet. The present invention presents a semantic ontology in the Internet scale machine tool communication method for representing both machine tool configuration and their operations to enable operating machine tools and manufacturing with various physically connected machine tools from geographically distributed locations over the Internet.

In one embodiment, the present invention provides an agent-adapter architecture of the communication method for exchanging manufacturing services across the Internet. The adapter interacts with a machine tool directly and an agent provides an interface of interchange of manufacturing data and operations over the Internet.

In another aspect, the present invention is an Internet-scale manufacturing service communication method that enables manufacturing operations over the Internet in addition to monitoring manufacturing services. The embodiments of the present invention are a significant improvement over MTConnect, a widely used communication method of manufacturing services which allows only monitoring machine tools over the Internet.

Additional objects and advantages of the invention will be set forth in part in the description which follows, and in part will be obvious from the description, or may be learned by practice of the invention.

In other embodiments, the present invention concerns a system and method that provides a method of communication for machine tools for exchanging their status information and performing their operations across the Internet.

In other embodiments, the present invention concerns a system and method that facilitates remote on-line monitoring and operations of the machine tools at both device level and component level over the Internet by exchanging messages of corresponding data in XML format.

In other embodiments, the present invention concerns a system and method that provides Internet scale communications to exchange manufacturing services in the cyber-physical manufacturing cloud.

In other embodiments, the present invention concerns a system and method that uses semantic ontological representations of machine tools for supporting both monitoring and operation of machine tools.

In other embodiments, the present invention concerns a system and method that is used for various types of devices including, but not limited to machine tools, such as CNC machines, robots, 3D printers using different machine specific languages, to be connected in a cyber-physical manufacturing cloud through RESTful web services.

In other embodiments, the present invention concerns a system and method that uses an agent-adapter architecture to transform manufacturing machine tools into IoT devices so that they can communicate with each other for exchanging their status information and executing their operations remotely over the Internet.

In other embodiments, the present invention concerns a system and method wherein the adapter has direct access to the machine tools.

In other embodiments, the present invention concerns a system and method wherein the adapter may be software or a combination of hardware and software, depending on the characteristics of the machine tools.

In other embodiments, the present invention concerns a system and method wherein the adapter accesses a machine tool in such a way through which it can collect data from the machine tool and also send operational commands to the machine tool.

In other embodiments, the present invention concerns a system and method wherein the adapter collects raw monitoring data and operation status directly from the machine tool in machine specific language.

In other embodiments, the present invention concerns a wherein the agent is the bridge that connects the machine tool to the internet for execution of their operations over the Internet.

In other embodiments, the present invention concerns a system and method wherein the agent is primarily a software program that works both as a translator and a server.

In other embodiments, the present invention concerns a wherein the agent uses schemas to perform the XML conversion.

In other embodiments, the present invention concerns a system and method wherein the agent receives status data from the adapter as a key-value pair based text dictionary and then converts this dictionary into a standard XML format.

In other embodiments, the present invention concerns a system and method including a semantic ontology which is designed to represent manufacturing resources and services.

In other embodiments, the present invention concerns a system and method including a semantic ontology that provides information about machine tools' status and operation not only at device level, but also at component and subcomponent level.

The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 illustrates a conceptual framework for the CPMC.

FIG. 2 illustrates the components that may be used for an embodiment of the present invention.

FIG. 3 shows the state transition diagram of an adapter that may be used for an embodiment of the present invention.

FIG. 4 shows the state transition diagram of an agent that may be used for an embodiment of the present invention.

FIG. 5 shows the semantic ontology of an embodiment of the present invention.

FIG. 6 provides a closer look into operations of an embodiment of the present invention.

FIGS. 7A and 7B show a probe document for an embodiment of the present invention.

FIGS. 8A and 8B show a sample current document for an embodiment of the present invention.

FIGS. 9A-A and 9A-B shows a sample single operation request document for an embodiment of the present invention.

FIGS. 9B-A and 9B-B show a sample multiple operations request document for an embodiment of the present invention.

FIG. 10 illustrates a preferred operating procedure for an embodiment of the present invention.

FIG. 11 illustrates an implementation of an embodiment of the present invention.

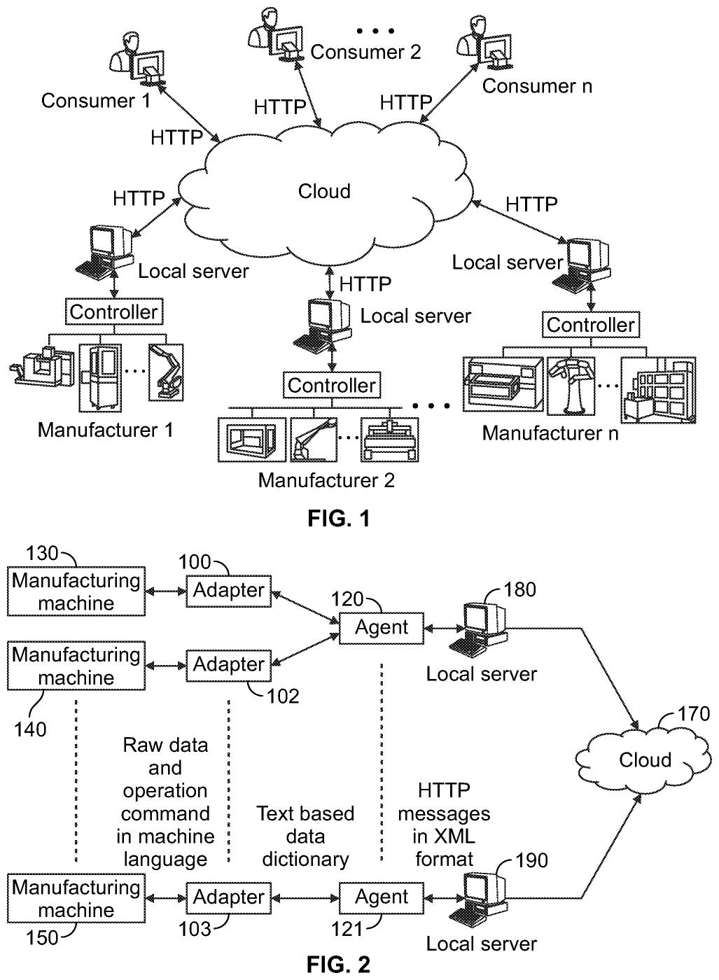

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

Establishing an IoT enabled CPMC system with different sorts of manufacturing machine tools faces a number of hindrances. Different machine tools use different machine-specific languages. Both monitoring data and operational commands vary from machine tool to machine tool. Moreover, some machine tools use manufacturer specific proprietary languages and communication protocols. This makes the communication both among the machine tools and between the machine tools and cloud very complex. One probable solution to this problem is to make the cloud capable of understanding every available manufacturing machine languages and communication protocols. But to do this, the cloud would require a more sophisticated architecture and additional resources.

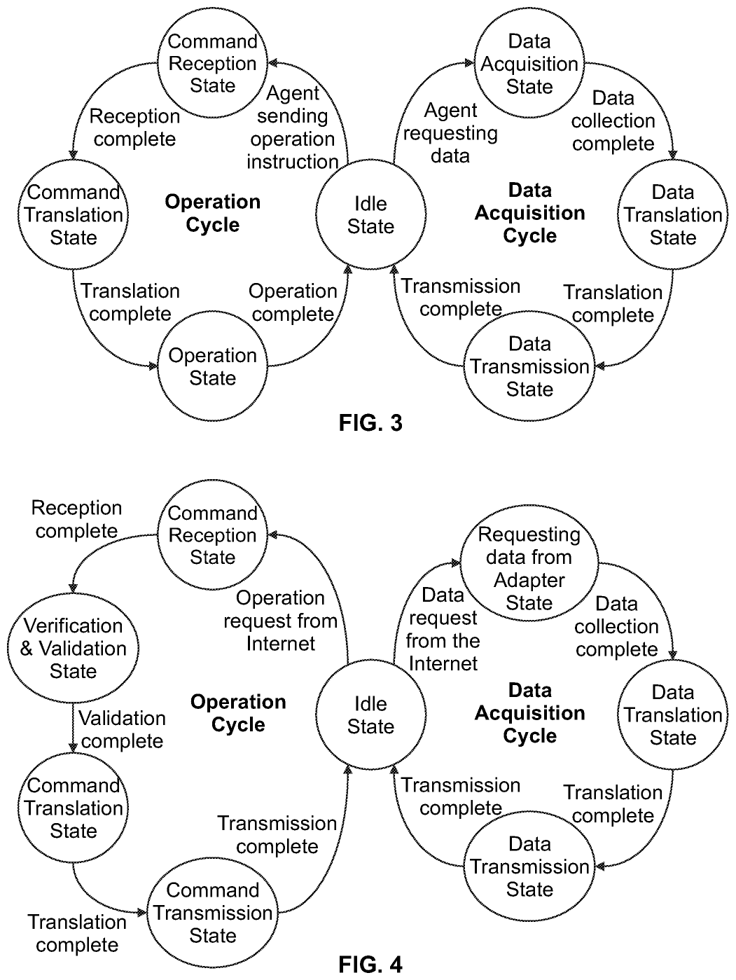

Developing a communication method that will communicate with the manufacturing machine tools in their own specific languages and will communicate with other machine tools and the cloud in a common structured machine-readable formats, such as XML and JSON, is more feasible and cost-effective. As shown in FIG. 2, to overcome these problems, certain embodiments of the present invention have been designed and developed to contain two components—one or more adapters 100, 102 and 103 and one or more agents 120 and 121. With the addition of the agent and adapter, ordinary manufacturing machine tools 130 140, and 150 are transformed into an IoT device by virtue of a connection to the cloud 160 and local servers 170 and 180.

In one embodiment, the adapter can be considered as an operator of a machine tool. It is the only component in the CPMC that has direct access to the machine tools. It performs as a gateway for the machine tools. The adapter is responsible for both collecting status data from a connected machine tool and sending commands to a connected machine tool for its operations. A machine tool requires its own adapter as a machine tool of a specific type typically has its own data format and a set of its own operations. The construction of the adapter can be different from machine tool to machine tool and it can be implemented as software, or a combination of hardware and software.

Adapter programs should be custom-written because semantics, units, and values of data usually differ from machine tool to machine tool and device to device. The interface between the adapter and machine tool can also be varied.

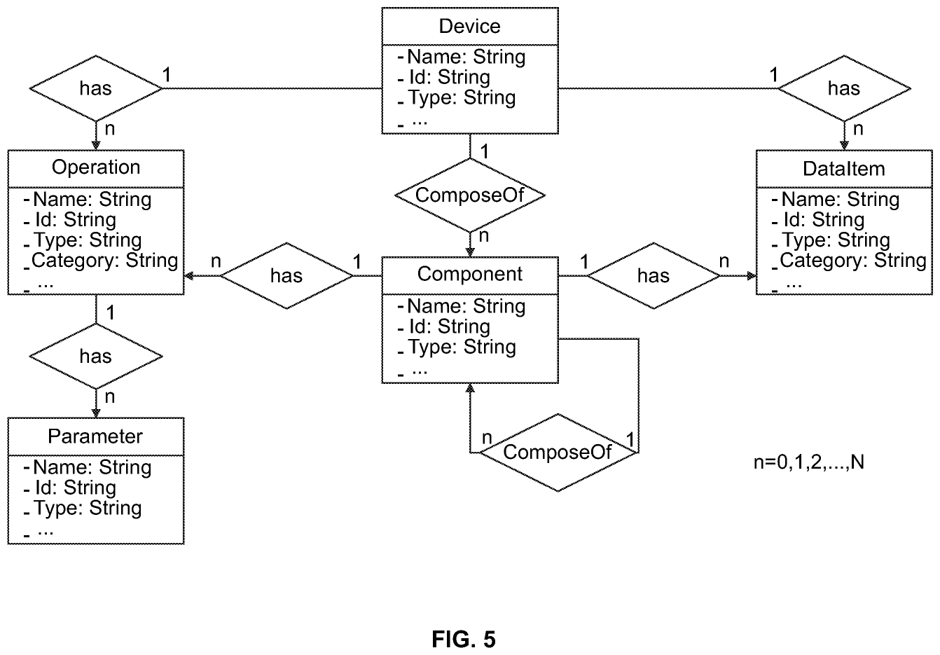

To acquire information on the status of a machine tool, the adapter is configured to collect raw monitoring data directly from the machine tool in a machine specific language. Common types of data are machine tool's availability, the position of the axes, temperatures, progress rate, and estimated time of the ongoing process, etc. The data acquisition process is dependent on the type of machine tools. For example, since many 3D printers and CNC machines use G-code, their adapters may send G-code based query and collects their responses. After acquiring the data from the machine, the adapter converts the acquired data into a key-value pair based text dictionary. The importance of this conversion is twofold. Firstly, it guarantees that data in various forms from machines or devices manufactured by many different vendors are presented to the agent in one common format. The design of adapter enables one agent to work with many types of adapters. Secondly, the dictionary makes it easier for the agent to convert the available data into a common machine-readable format. Once the dictionary is created, it is sent to the agent for additional processing. The data acquisition can be performed periodically. The time period between each cycle of data acquisition is determined by designer of the adapter. The process of operating machine tools using the adapter is in a reverse order. In order to perform an operation of the machine tool over the Internet, the adapter either sends a command to the machine tool to perform the requested operation or execute a program to complete the operation. Both processes of data acquisition and operation of the adapter with intermediate states are shown in FIG. 3.

The one or more agents of the present invention are responsible for the bulk of the communications and act as a bridge that connects a machine tool to another machine tool or to the Internet. It is primarily a software program that works both as a translator and a server. In a data acquisition process, it first receives status data from the adapter as a key-value pair based text dictionary as previously described. It then converts this dictionary into a document in a standard XML format. This conversion is done based on the semantic ontology used which is designed to represent manufacturing resources and operations.

In other embodiments, schemas may be developed and used to perform XML conversion. The schemas are based on the semantic ontology of MTComm. The agent hosts an HTTP server to publish the status data in XML format across the Internet and to receive operation requests from agents of other machine tools or the cloud. Thus, the agent adds IoT capabilities to the machine tool. Functionalities of agents are provided as RESTful web services.

In other aspects of the present invention, when initiating an operation of a particular machine tool, a request for the operation is sent to its agent. The request message is represented in XML format. Upon receipt, the agent validates and verifies the incoming request in order to ensure the safety of the machine. Once verified, the agent translates the request into a text-based dictionary and sends it to the adapter. The actual operation is carried out by an adapter associated with the tool.

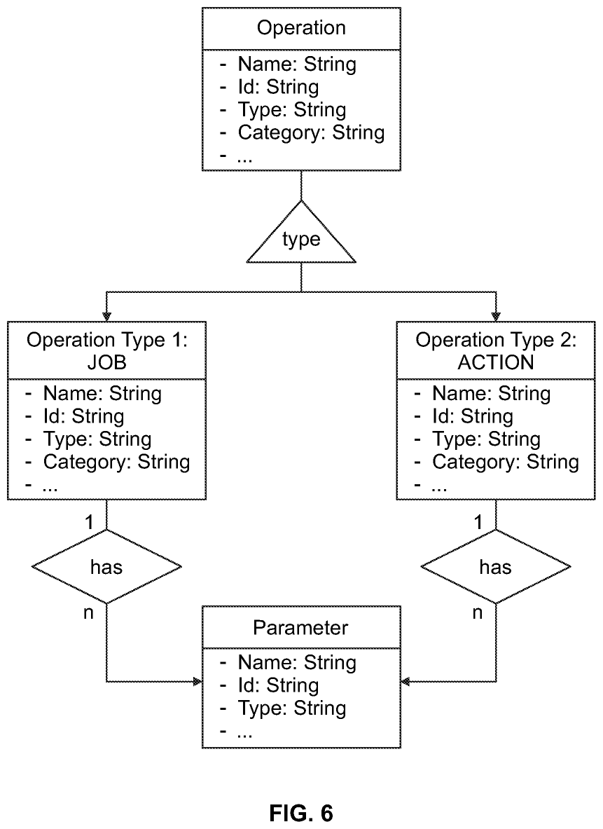

The agent needs to have sufficient buffer storage for storing both status data and operation. If the buffer becomes overfilled, the agent deletes older and unnecessary data and operations. All web services hosted by the agent are RESTful. The state diagram of the agent is shown in FIG. 4.

In other aspects, the present invention uses a semantic ontology to represent a manufacturing machine tools' data and operations. Machine tool data may include but is not limited to machine configuration data, machine characteristics data, machine diagnosis data, manufacturing service data, and manufacturing process data. Operations include commands and their parameters. This ontology is regarded as an upper ontology, which is a lightweight ontology limited to concepts that are abstract and generic enough to address a broad range of objects in the domain of interest. Therefore, while providing a level of standardization, an upper ontology has sufficient flexibility and extendibility necessary for the conceptualization of highly heterogeneous and dynamic domains. In a preferred embodiment, the ontology represents the structure of machine tools and their components and contains their data and operations in a top-down fashion.

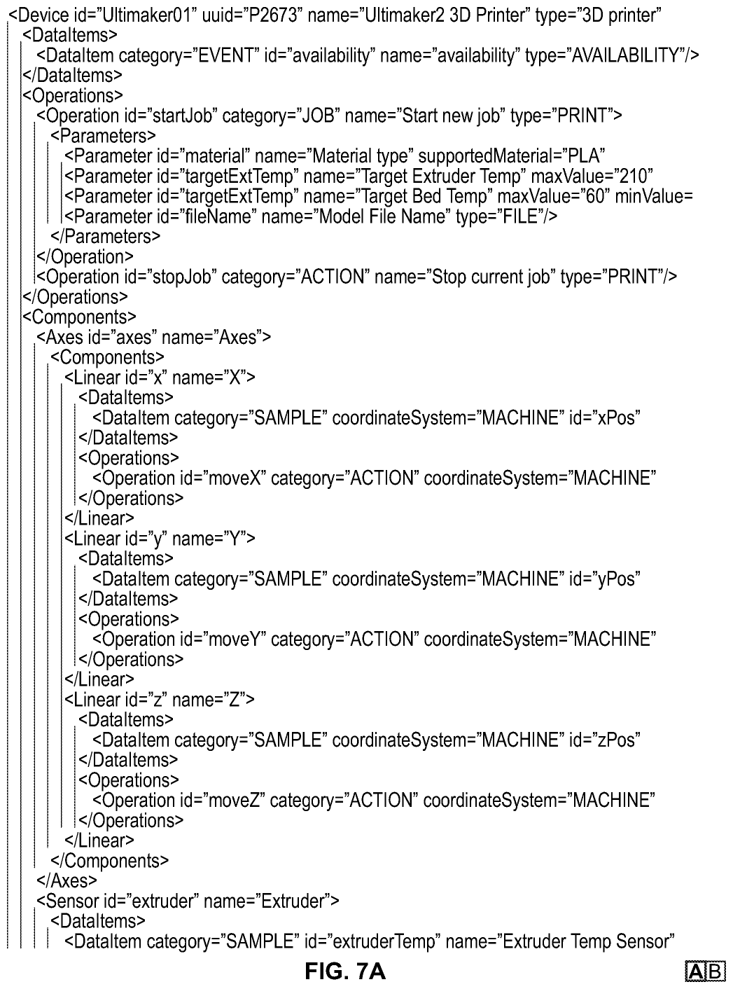

FIG. 5 shows an ontology of MTComm that provides information about a machine tools' status and operations not only at a machine tool level but also at component and subcomponent level. It provides a foundation for translation of data sent from/to manufacturing machine tools.

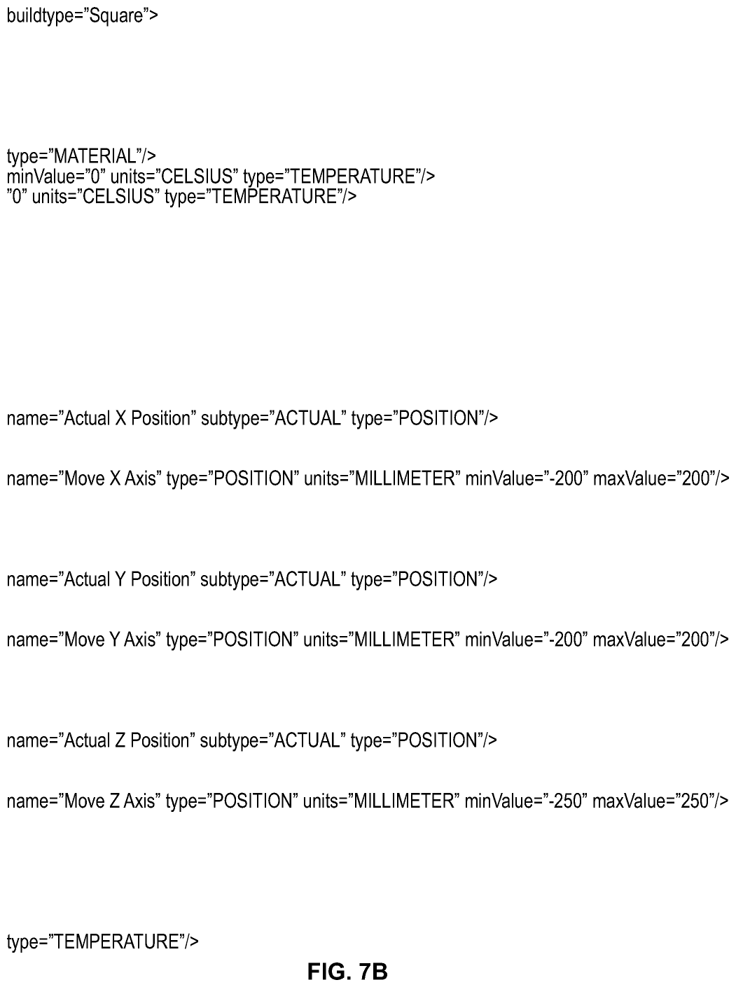

In the hierarchical representation of manufacturing machine tools, a machine tool consists of multiple components and/or subcomponents. A machine tool or component can have one or more dataitems and operations. A dataitem represents a piece of status information that can be collected from the machine tool or its components. An operation represents a manufacturing activity that can be performed by the machine tool or its components. A dataitem has several attributes such as name, id, data type, category, and unit type. Types of operations are shown in FIG. 6. The operations are divided into two categories—JOB and ACTION. A JOB is an operation that is performed by a machine tool as a whole and an ACTION denotes an operation conducted by a specific component or subcomponent of the machine tool. Both types of operations may contain parameters. For instance, a 3D printing JOB typically requires several parameters, such as the type of material to be used, temperature of the extruder, model, or g-code file.

As this ontology is primarily designed for Internet-based communication of machine tools, all information transferred over the Internet is represented in XML format. XML provides an interchangeable data format over the Internet based on a scalable hierarchical data structure. It is easy for machines and applications to read and parse data in XML format. The ontology provides a hierarchical representation of both monitoring data and operations of machine tools.

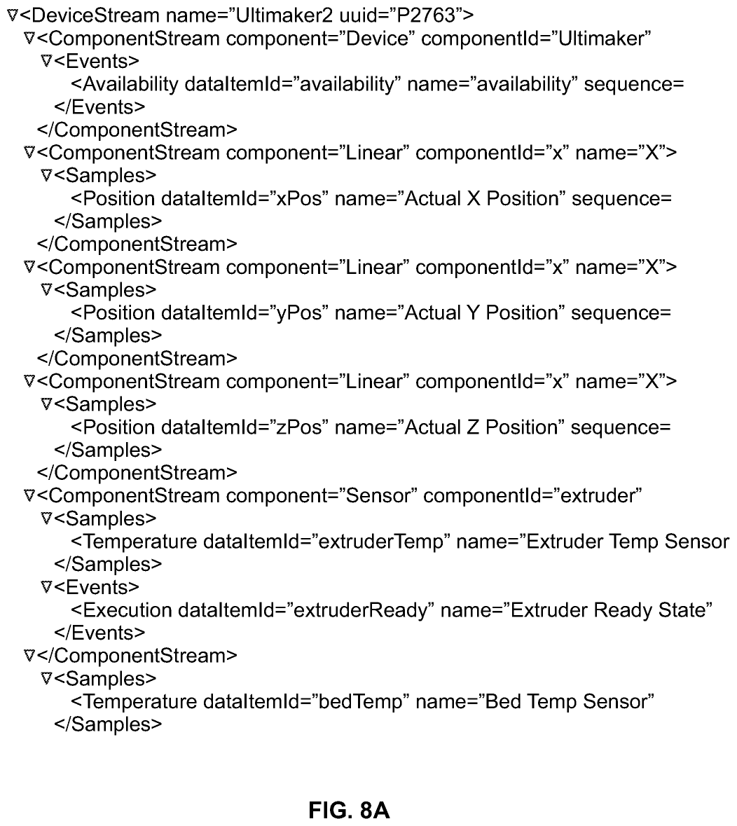

In other embodiments, the data acquisition process of the present invention may involve three different types of services and XML documents for monitoring: 1) probe, which provides configuration information of a machine tool including all available monitoring data types and operations. FIG. 7 shows a portion of a sample probe document for a 3D printer; 2) current, which provides the current status of the machine. 3) Sample, which provides status information for a time interval.

The machine tool itself may be described as a device. The device tag may have attributes that represent characteristics of one or more machine tools. In the probe protocol and document, dataitems are defined and categorized. The basic attributes of dataitems and operations are id, name, category, and type. The ontology defines the most basic structure of the XML document, and it can be expanded. For example, in the example of probe document, the components are classified into Axes and Sensor. The probe document is accessible from an agent.

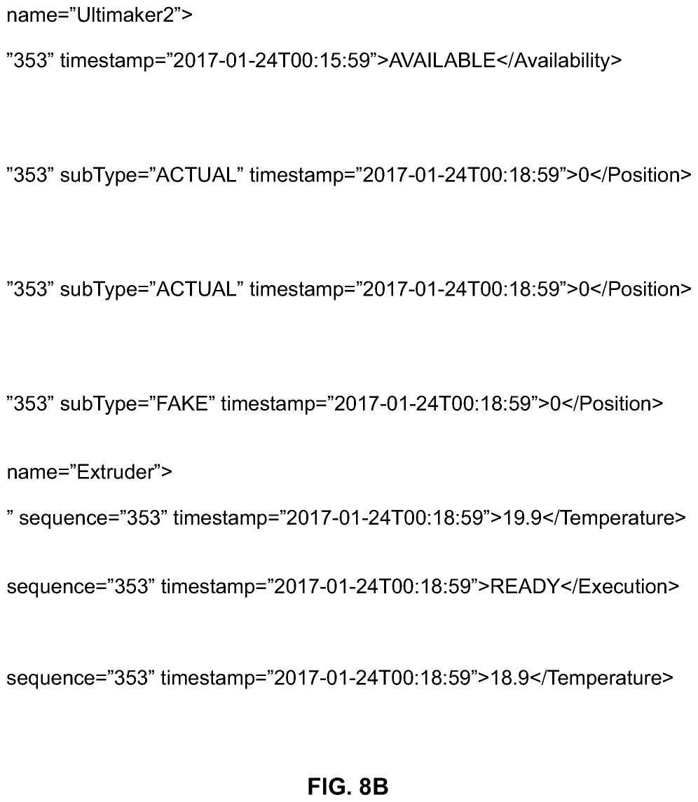

Data about the current status of a machine tool are collected by an adapter and converted to a text dictionary. The agent converts this data into an XML document using schemas and makes it available to agents of other machine tools and cloud applications over the Internet. A sample of current document is shown in FIG. 8. The organization of the current document is different than the probe document. It uses the category attribute of the dataitems to label the present values of the dataitems. Also, every value has timestamp and sequence number to help the receiver keep track of the data. The current protocol and document also include operation information.

These protocols can be used independently or in cyber manufacturing. In a cyber-physical manufacturing cloud environment, when a machine tool is registered with a cyber-physical manufacturing cloud, its web services are added in the cloud's service repository. It contains information of these web services, such as URL of each service. The cloud sends an HTTP GET request for both probe and current with the corresponding URL.

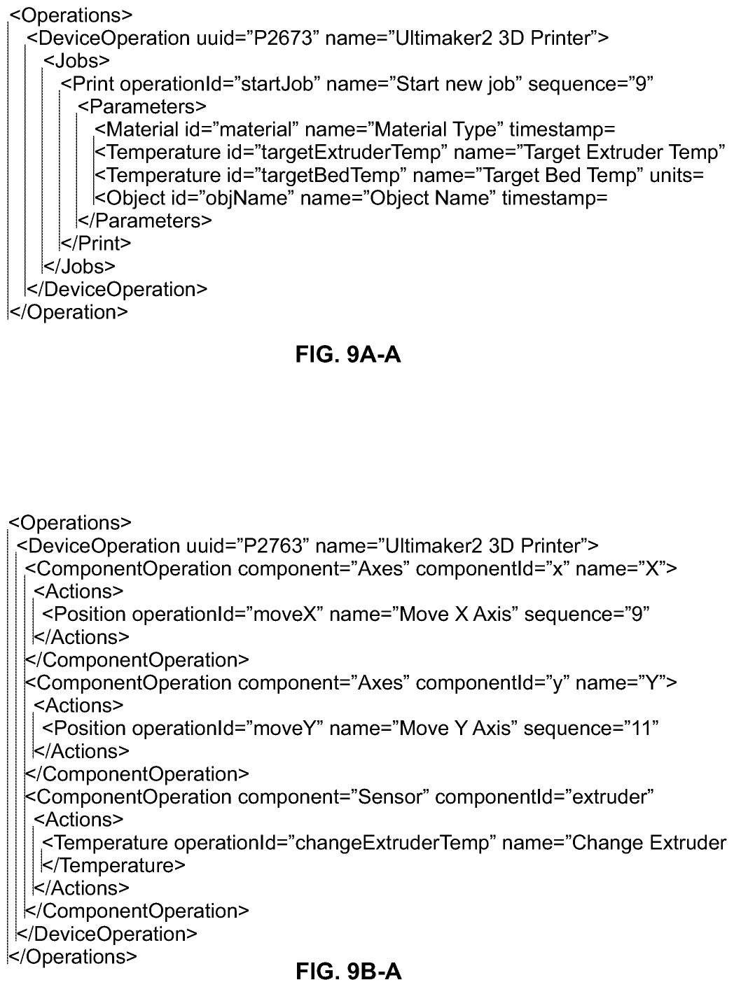

The operations of the present invention are of two types: 1) JOB which is a machine tool level operation, and 2) ACTION which is a component specific operation. Operations of a machine tool can be performed by sending an operation request to its agent directly from another machine tool or a cyber-physical manufacturing cloud. In a cyber-physical manufacturing cloud environment, a user can perform a probe service to obtain configuration information of the machine tool and a list of its operations. An operation service and XML document contain the specification of the requested operation, such as the type of operation and its parameters. The embodiments of the present invention may be configured to support multiple operation requests in one single message. The agent performs validation and verification of an operation request in XML to avoid damages of invalid operations. FIG. 9A contains an example of an operation request message with a single operation with sequence numbers indicating their execution ordering. FIG. 9B contains an example of an operation request message with multiple operations with sequence numbers indicating their execution ordering.

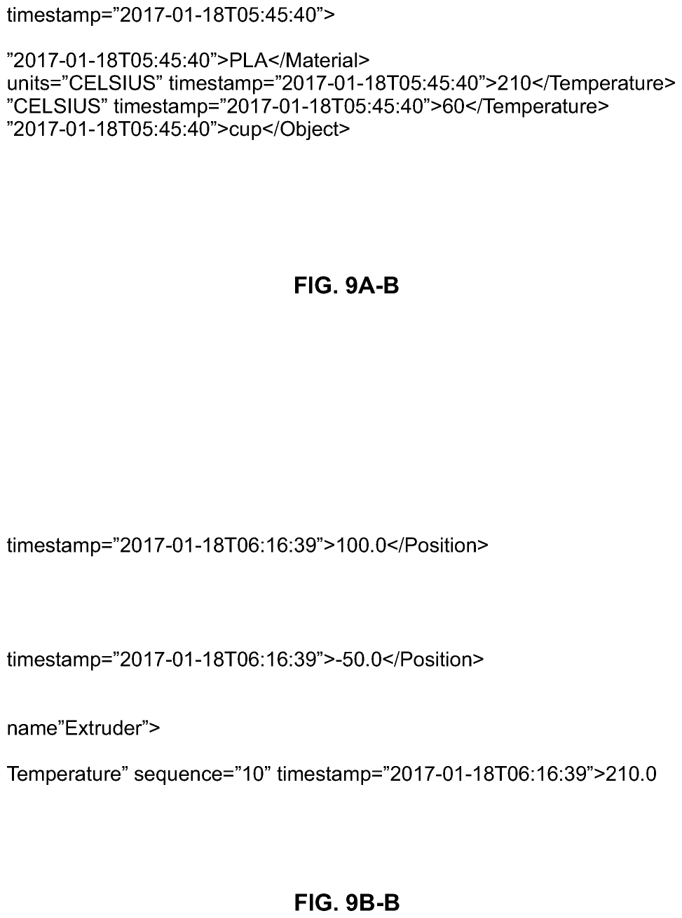

Once the operation request is validated and verified, the agent parses its operation XML document and produces a text-based dictionary in a sequence of key-value pairs for the adapter. Once the adapter receives the dictionary, it sends commands to the machine tool to perform the operation. As the machine starts the operation, the status of the machine tool is changed from ‘AVAILABLE’ to ‘BUSY’. FIG. 10 shows an example of performing an operation using MTComm in a cyber-physical manufacturing cloud.

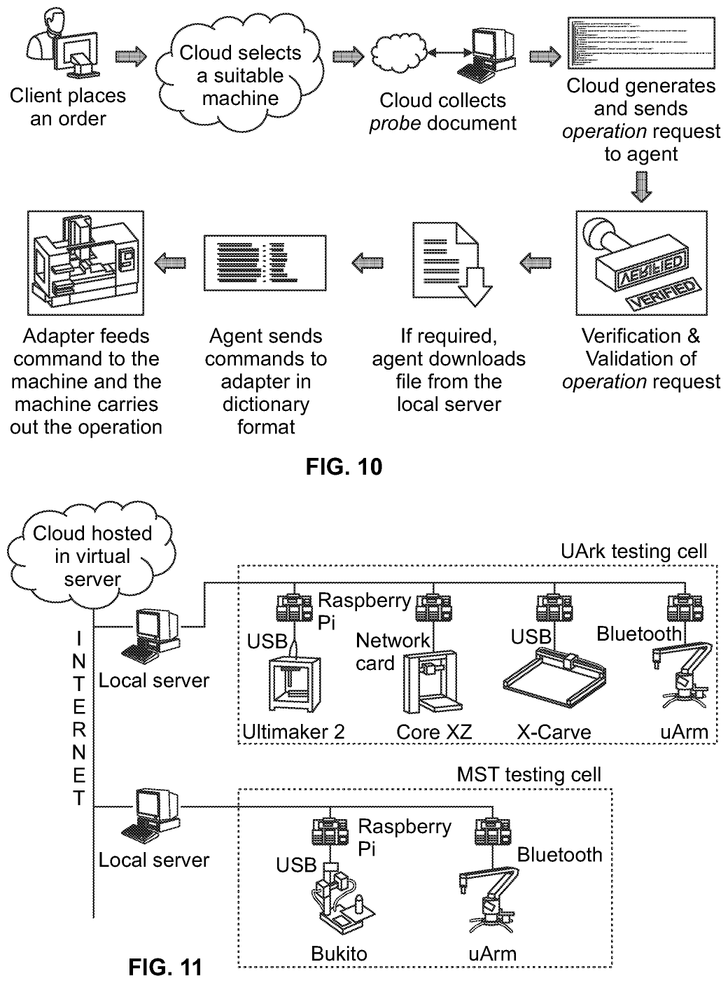

The performance and effectiveness of the of the present invention were tested with a testbed of the CPMC. The structure of the testbed is shown in FIG. 11. The cloud has been hosted on a virtual server. The cloud provides access to both manufacturers and customers. Manufacturers can register their machines and publish their manufacturing services as web services. The RESTful web services are hosted on a local server. Each local server may be hosted on a desktop machine running a Linux server. The local servers have the directory of IP addresses of all agents of the associated machine tool.

The testbed consists of three separate testing cells. Two cells are located at one location and another is remotely located. The purpose of having three testing cells is to demonstrate the capability of the present invention to connect and operate manufacturing resources from different locations over the Internet. One location has three machines—an X-Carve CNC machine from Inventables, a small robotic arm from UFactory, and a RepRapc 3D printer from Ultimaker. Another cell has a robotic arm from UFactory and a custom-made RepRap 3D printer called Core XZ. The other cell from the other location consists of two machines—a small robotic arm and a RepRap 3D printer from Bukobot. All these machines are based on open-source software. Each cell may have a dedicated local server. The local servers work as gateways between the cells and the cloud. All communications between the machine tools and the cloud are transferred through the servers. Each machine tool is connected to a Raspberry Pi (RPi) which works as a controller of that machine tool. Both the agent and adapter programs are deployed in the RPi. These programs may be developed in python. The programs use the RPi's memory as their buffer storages. The RPis are connected to the local network via Ethernet and Wi-fi. The connection types between the RPis and the machines are varied—via USB, Bluetooth or Wireless network card.

The embodiments of the present invention were tested with a variety machine tools. The schemas have been developed for the 3D printers, CNC machine, and Robot arms. Each machine tool provides a certain number of services. The 3D printer can print three types of objects with gray colored thermoplastic Polylactide (PLA)—a cup, a clip and a ring. The other 3D printer can produce 2 objects with violet colored PLA—a square box and a circular ball. The CNC machine can drill and curve 3 kinds of designs into wood and plastic boards. The robotic arm is used to remove the produced object from other machines. In this case, the verification process of the operation request is carried out by the agent. The associated files for these operations are stored in the RPis' memory. The cloud has a service repository that keeps track of all the registered machine tools with the address of the associated local server. Alongside the device level job (printing for the 3D printers and drilling for the CNC machine), the machine tools of the testbed also support several additional JOBs, such as ‘RESET’—resetting a machine to default idle state, ‘STOP’—stopping an ongoing operation, ‘PAUSE’—halting an operation, and ‘RESUME’—resuming a paused operation. The robotic arms can remove an object from a pre-specified location to another location through the ‘REMOVE’ operation. Also, several ACTION type operations are also available for the machine tools like changing the x, y and z-axis position, and changing the temperature of the extruder and heat bed (for 3D printers)

Several manufacturing experiments were conducted using several scenarios: 1) All machine tools are ‘AVAILABLE’; 2) some of them are ‘AVAILABLE’; and 3) All of them are ‘BUSY’. The machine tools have successfully completed their requested operations and the cloud has displayed the status of the machine tools correctly in all the scenarios. The requests have been placed remotely from multiple locations. Experiments conducted demonstrate effectiveness of the present invention to perform requested manufacturing operations remotely.

The present invention provides an Internet scale communication method of machine tools for exchanging manufacturing services and enabling operations of machine tools over the Internet through RESTful web services in addition to their monitoring services. The semantic ontology of the present invention provides a uniform representation of configuration and operations of heterogeneous machine tools so that they can exchange their information and services. The agent-adapter architecture of the present invention enables machine tools to communicate with each other or through a cyber-physical manufacturing cloud. The communication method facilitates remote on-line monitoring and operations of the machines at both device level and component level. The tests conducted with a testbed of a cyber-physical manufacturing cloud demonstrate the feasibility and effectiveness of the present invention for both acquisition of status information of machine tools and operations across the Internet.

The embodiments of the present invention may be used in a wide variety of applications other than those described above. Other uses or applications include, but are not limited to, online additive manufacturing marketplaces; the offering that effect trade services over the Internet using digital manufacturing machines such as CNC machines, 3D printers, robotic arms, etc.; Internet Of Things products (IoT) and services; cloud-based manufacturing services and Manufacturing Execution Systems (MES); and Internet enabled equipment for power grids, water supplies and gas supplies.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

1. A system of connected devices comprising:
a plurality of machine tools, said machine tools adapted to communicate with one another;
at least one agent and at least one adapter; and
said at least one agent and at least one adapter both configured to form an agent-adapter architecture, said agent-adapter architecture adapted to incorporate said plurality of machine tools into a connected group that directly communicates with each other for exchanging their status information and remotely over the Internet; and
said executed operations are actions to be performed by a machine tool and are communicated directly between said machine tools.

2. (canceled)

3. The system of claim 1 wherein said machine tools are from the group consisting of CNC machines, robots, and 3D printers, each using different machine specific languages.

4. The system of claim 1 wherein said machine tools are configured to be capable of remote on-line monitoring and operations over a network by exchanging messages of corresponding data in XML format.

5. The system of claim 1 further including semantic ontological representations of said machine tools for supporting both monitoring and operation of said machine tools.

6. The system of claim 1 wherein each machine tool has a dedicated adapter that has direct access to said machine tool.

7. The system of claim 6 wherein said adapter is configured to accesses a machine tool to collect data from the machine tool and to send operational commands to the machine tool.

8. The system of claim 7 wherein the adapter collects raw monitoring data and operation status directly from the machine tool in machine specific language.

9. The system of claim 8 wherein said agent is a bridge that connects one or more machine tools to a network for execution of their operations over the network.

10. The system of claim 9 wherein said agent works both as a translator and a server.

11. The system and method of claim 10 wherein said agent uses schemas to perform the XML conversion.

12. The system of claim 11 wherein said agent receives status data from an adapter as a key-value pair based text dictionary and then converts said dictionary into a standard XML format.

13. The system of claim 12 wherein said agent is adapted to receive an operation request having an XML document, said agent validates and verifies said operation request and then parses said XML document and produces a text-based dictionary in a sequence of key-value pairs for said adapter; said adapter receives the dictionary and sends commands to said machine tool to perform the received operation.

14. The system of claim 1 further including a semantic ontology which is designed to represent manufacturing resources and services.

15. The system of claim 1 further including a semantic ontology that provides information about the status and operation of said machine tools.

16. A system of connected devices comprising:
a plurality of machine tools to be connected;
at least one agent and at least one adapter;
said at least one agent and at least one adapter both configured to form an agent-adapter architecture, said agent-adapter architecture adapted to transform said machine tools into a connected group that communicate directly with each other for exchanging their status information and executing operations remotely over a network; and
said executed operations are actions to be performed by a machine tool and are communicated directly between said machine tools.

17. The system of claim 16 wherein said system each machine tool has a dedicated adapter that has direct access to said machine tool; said adapter is configured to accesses one or more machine tools to collect raw monitoring data collect data from said machine tools and to send operational command to said machine tools; said agent is a bridge that connects one or more machine tools to a network for execution of their operations over the network and works both as a translator and a server.

18. The system claim 17 wherein said agent uses schemas to perform the XML conversion.

19. The system of claim 17 wherein said agent receives status data from an adapter as a key-value pair based text dictionary and then converts said dictionary into a standard XML format.

20. The system of claim 17 wherein said agent is adapted to receive an operation request having an XML document, said agent validates and verifies said operation request and then parses said XML document and produces a text-based dictionary in a sequence of key-value pairs for said adapter; said adapter receives the dictionary and sends commands to said machine tool to perform the received operation.
